(19) United States
(12) Patent Application Publication
(10) Pub. No.: US 2002/0082896 A1
(43) Pub. Date: Jun. 27, 2002

(54) POS terminal maintenance server and remote maintenance systems of POS terminals using the server

(75) Inventor: Yoshitaka Inagi, Mishima-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 09/998,064

(22) Filed: Nov. 30, 2001

(30) Foreign Application Priority Data
Dec. 25, 2000 (JP) 2000-393386

(51) Int. Cl. G06F 17/60

(52) U.S. Cl. 705/9

(57) ABSTRACT

A server determines whether or not replacement of at least one of parts of a POS terminal is necessary based on actual operation data of the respective pats of the POS terminal. If it is determined that replacement of the part is required, the schedule of a store manager and the schedule of a maintenance operator are collated with each other to determine a part-replacement operation date. Then, notification about the part-replacement operation date is given.

### CROSS-REFERENCE TO RELATED APPLICATIONS

This application is based upon and claims the benefit of priority from the prior Japanese Patent Application No. 2000-393386, filed Dec. 25, 2000, the entire contents of which are incorporated herein by reference.

### BACKGROUND OF THE INVENTION

1. Field of the Invention

This invention relates to a server provided in a maintenance center in which POS terminals operated in respective stores are maintained and a remote maintenance system of POS terminals using the server.

2. Description of the Related Art

A POS terminal disclosed in Jpn. Pat. Appln. KOKAI Publication No. 10-283568 accumulates parameters indicating factors of consumption of parts for respective parts. If a part corresponding to the accumulated value which has reached a preset reference value is detected, an instruction for replacing the part is transmitted from the POS terminal to the maintenance center by use of communication.

In a case where the above POS terminal is used and if a maintenance operator of the maintenance center confirms that the instruction of replacement of the part is transmitted from the POS terminal, he makes contact with the manager of the store in which the POS terminal is operated by use of a telephone, FAX or electronic mail. Then, the operator decides a date on which the operation for replacing the part (part-replacement operation date) is performed by adjusting their work schedules.

Thus, conventionally, the part-replacement operation date is decided after the maintenance operator of the maintenance center makes contact and consults with the manager of the store. Therefore, it takes a lot of time and labor to decide the part-replacement operation data, which is the problem to be solved.

### BRIEF SUMMARY OF THE INVENTION

According to an aspect of the present invention, there is provided a server to maintain a POS terminal comprising a first storage section which stores a schedule of a manager of a store in which the POS terminal is operated; a second storage section which stores a schedule of a maintenance operator who is in charge of maintenance of the POS terminal; a determining section which determines whether replacement of respective parts of the POS terminal is necessary or not based on actual operation data of the respective parts in the POS terminal; a deciding section which decides a part-replacement operation date by collating the schedule of the manager of the store stored in the first storage section and the schedule of the maintenance operator stored in the second storage section with each other if the determining section determines that replacement of at least one part of the POS terminal is necessary; and a notifying section which gives notification about the part-replacement operation date decided by the deciding section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiment given below, serve to explain the principles of the invention.

FIG. 1 is a diagram showing the system configuration according to one embodiment of this invention;

FIG. 2 is a block diagram showing the configurations of the main portions of a store computer and POS terminal maintenance server in the above embodiment;

FIG. 3 is a diagram showing the configuration of a POS state data file in the above embodiment;

FIG. 4 is a diagram showing the configuration of a store manager schedule file in the above embodiment;

FIG. 5 is a diagram showing the configuration of a store management data file in the above embodiment;

FIG. 6 is a diagram showing the configuration of a maintenance operator schedule file in the above embodiment;

FIG. 7 is a flow diagram showing the main portion of a POS terminal remote maintenance process performed by the POS terminal maintenance server in the above embodiment;

FIG. 8 is a diagram showing one example of an electronic mail transmitted from the POS terminal maintenance server to the store computer in the above embodiment;

FIG. 9 is a diagram showing the configuration of a store management data file in another embodiment of this invention; and

FIG. 10 is a flow diagram showing a POS terminal remote maintenance process performed by a CPU of the POS terminal maintenance server in the above embodiment.

### DETAILED DESCRIPTION OF THE INVENTION

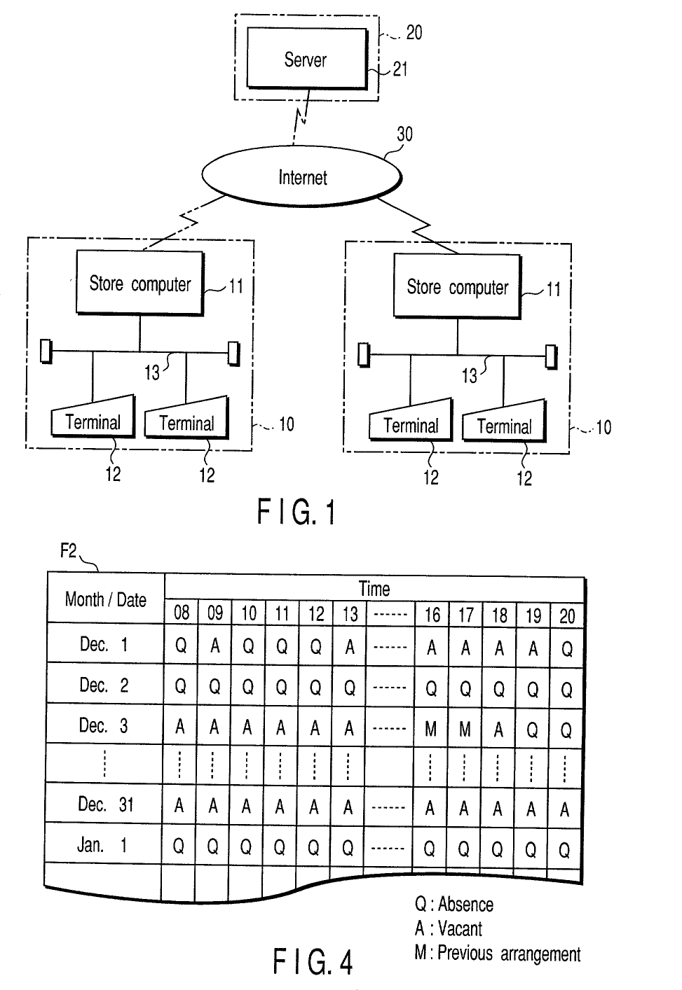

First, a first embodiment is explained with reference to FIGS. 1 to 8.

FIG. 1 is a diagram showing the system configuration of the first embodiment.

One store computer 11 and a plurality of POS terminals 12 are installed in each of the stores 10. The store computer 11 is connected to the POS terminals 12 via a LAN 13. A server 21 which is used for maintaining the POS terminals 12 is installed in a maintenance center 20. The server 21 and the store computer 11 of each store are connected with each other via Internet 30.

The POS terminal 12 is configured by parts such as a CPU, ROM, RAM, keyboard, operator display, customer display, receipt printer, hard disk drive device and drawer.

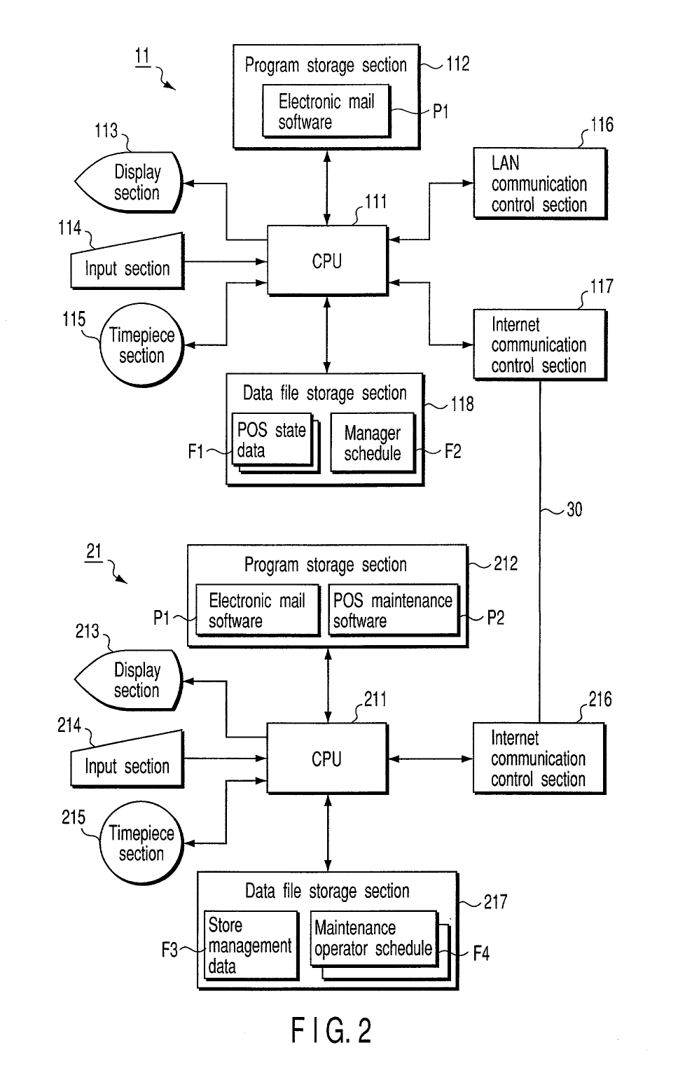

FIG. 2 is a block diagram showing the configurations of the main portions of the store computer 11 and POS terminal maintenance server 21.

The store computer 11 includes a CPU 111. A program storage section 112, display section 113, input section 114, timepiece section 115, LAN communication control section 116, Internet communication control section 117, data file storage section 118 and the like are controlled by the CPU 111. The timepiece section 115 is configured to keep the present date and time. The LAN communication control section 116 is configured to control data communication performed by use of the LAN 13. The Internet communication control section 117 is configured to control data communication performed by use of Internet 30.

Software P1 which is used to transmit or receive an electronic mail is installed in the program storage section 112.

A POS state data file F1 and store manager schedule file F2 are stored in the data file storage section 118.

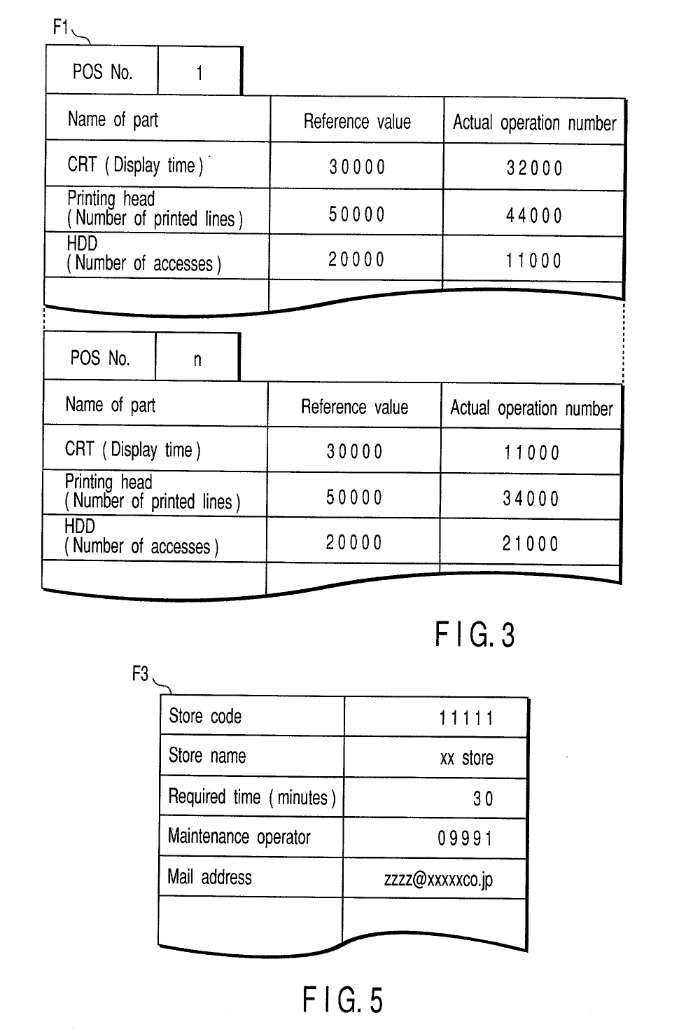

FIG. 3 is a diagram showing the configuration of the POS state data file F1.

The POS state data file F1 is configured to store actual operation data of parts which may be required to be replaced due to consumption thereof among the parts configuring the POS terminal 21 for every POS numbers. Further, the POS state data file F1 is configured so that reference values which are used to determine whether replacement of corresponding parts is necessary or not may be set in correspondence to the actual operation data items of the respective parts. The POS numbers are unique numbers previously assigned to the POS terminals 12 connected to the store computer 11 via the LAN 13.

In the present embodiment, as parts which may be required to be replaced due to consumption, a CRT display used as the operator display, a printing head provided in the receipt printer, and a hard disk drive device are provided. As to the CRT display, display time is accumulated as actual operation data. As to the printing head, the number of printing lines is accumulated as actual operation data. As to the hard disk drive device, the number of accesses is accumulated as actual operation data.

FIG. 4 is a diagram showing the configuration of the store manager schedule file F2.

The store manager schedule file F2 is configured to store daily work schedule data of the manager who is in charge of the store 10. The work schedule data of one day is set in units of hours. In the time zone in which the person is absent and there is no work schedule (holiday, going out, before coming to the office, after going back home, or the like), data “Q” is set. In the time zone in which a work schedule is vacant (no schedule), data “A” is set. In the time zone in which a work schedule is a previous arrangement, data “M” is set.

The operator of the store computer 11 can set the work schedule data “Q”, “A” or “M” in a given date and time area in the store manager schedule file F2 by operating the input section 114.

The POS terminal maintenance server 21 includes a CPU 211. A program storage section 212, display section 213, input section 214, timepiece section 215, Internet communication control section 216, data file storage section 217 and the like are controlled by the CPU 211. The timepiece section 215 is configured to count the present date and time. The Internet communication control section 216 is configured to control data communication performed by use of Internet 30.

Software P2 which is used to perform the remote maintenance operation of the respective POS terminals 12 set in each of the stores 10 is installed together with the software P1 which is used to transmit or receive an electronic mail in the program storage section 212.

A store management data file F3 and maintenance operator schedule file F4 are stored in the data file storage section 217.

FIG. 5 is a diagram showing the configuration of the store management data file F3.

The store management data file F3 is configured to store the name of the store 10, time (minutes) required for the maintenance operator to go to the store 10 from the maintenance center 20, an ID code of the maintenance operator in charge of maintenance of the store 10, an address of an electronic mail acquired by the store 10 and the like in correspondence to a unique store code previously assigned to each of the stores 10. Further, it is permitted for one maintenance operator to take charge of maintenance of a plurality of stores.

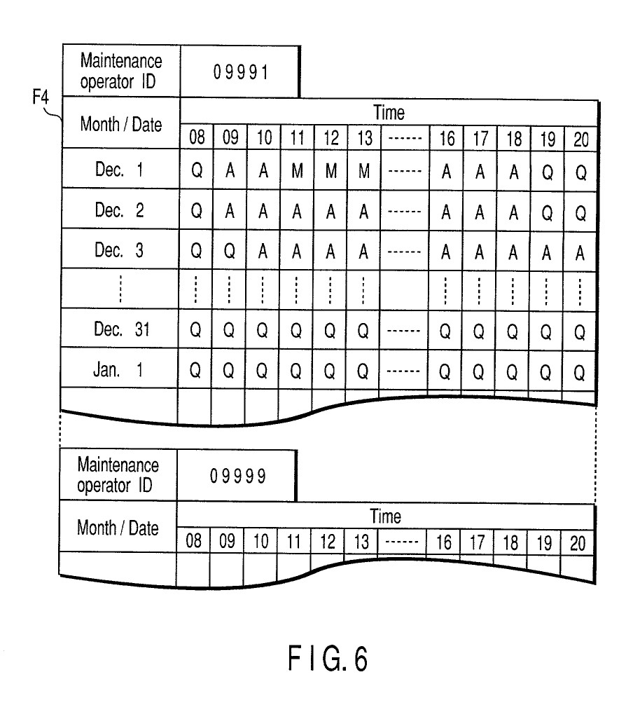

FIG. 6 is a diagram showing the configuration of the maintenance operator schedule file F4.

The maintenance operator schedule file F4 is configured to store daily work schedule data of each maintenance operator for each maintenance operator. The work schedule data of one day is set in units of hours. In the time zone in which the person is absent and there is no work schedule (holiday, going out, before coming to the office, after going back home, or the like), data “Q” is set. In the time zone in which a work schedule is vacant (no schedule), data “A” is set. In the time zone in which a previous arrangement is set as a work schedule, data “M” is set.

The operator of the server 21 can set the work schedule data “Q”, “A” or “M” in a given date and time area of a desired maintenance operator ID code in the maintenance operator schedule file F4 by operating the input section 214.

In the server 21, the software P2 used for performing the remote maintenance operation of each POS terminal 12 is started when time counted by the timepiece section 215 reaches a previously set time. As a result, the CPU 211 starts to execute the remote maintenance process of the POS terminal.

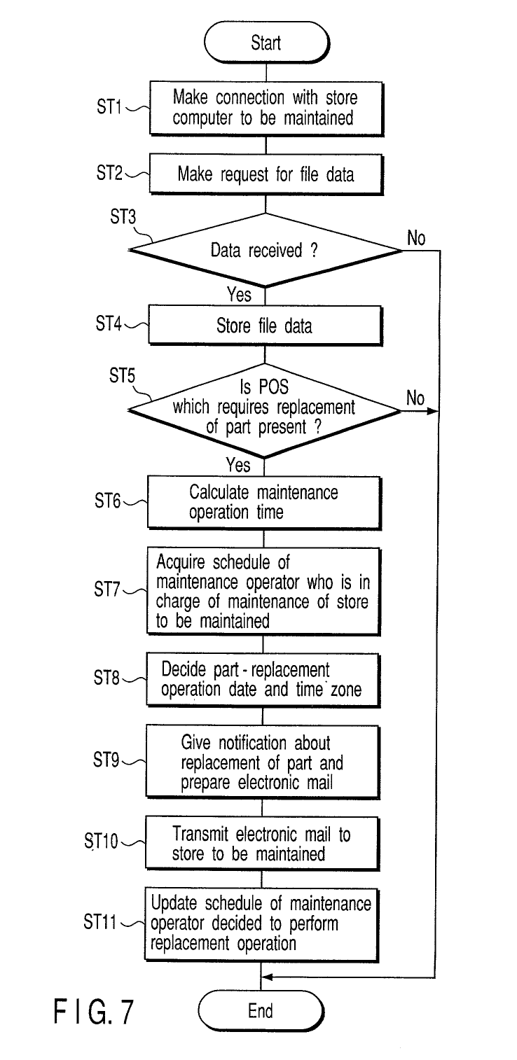

FIG. 7 is a flow diagram showing the main portion of the POS terminal remote maintenance process.

First, the CPU 211 selects one of the stores managed according to the store management data file F3 as a store to be maintained in the step ST1. Then, it transmits a command which requests connection of the line to the store computer 11 of the store to be maintained via Internet 30. As a result, the line is connected between the server 21 and the store computer 11 of the store to be maintained. At this time, the CPU 211 transmits a command which requests fetching of the POS state data file F1 and store manager schedule file F2 via Internet 30 in the step ST2.

Thus, data of both of the files F1, F2 is transmitted from the store computer 11 to the CPU 211 via Internet 30. Then, if the CPU 211 receives the data of both of the files F1, F2 in the step ST3, it temporarily stores the data of both of the files F1, F2 in the step ST4. Further, it cuts off the line with the store computer 11.

Next, the CPU 211 determines the presence or absence of at least one POS terminal 12 which requires replacement of the part based on data of the POS state data file F1 received from the store computer 11 in the step ST5. The determination method is more specifically explained below. First, the CPU 211 compares the number of actual operations of each part with the corresponding reference value for the respective POS numbers. Then, if a part having the number of actual operations which exceeds the reference value is detected, the POS terminal 12 to which the POS number is attached determines that replacement of the corresponding part is necessary.

In this case, if only one of the POS terminals 12 which requires replacement of the part is present, the CPU 211 calculates the maintenance operation time Z1 (minutes) on the maintenance operator side and maintenance operation time Z2 (minutes) on the store side based on the following equations [1] and [2] in the step ST6.

Z1=nX+2Y [1]

Z2=nX+Y [2]

where n denotes the number of parts which are required to be replaced. X (minutes) denotes average time required for the operation of replacing one part. Y (minutes) denotes time required for the maintenance operator to move from the maintenance center 20 to the store 10 to be maintained. The required time Y (minutes) is set in the store management data file F3.

Next, the CPU 211 acquires an ID code of the maintenance operator who takes charge of maintenance of the store to be maintained from the store management data file F3 in the step ST7. Then, it searches the maintenance operator schedule file F4 by use of the maintenance operator ID code and fetches maintenance operator schedule data stored in correspondence to the maintenance operator ID code.

Next, the CPU 211 collates the maintenance operator schedule data fetched from the maintenance operator schedule file F4 with the store manager schedule data of the store manager schedule file F2 received from the store computer 11 to decide a part-replacement operation date and time zone in the step ST8. The above deciding method is more specifically explained. That is, the CPU 211 derives a time zone in which no schedule is set from the maintenance operation time Z1 on the maintenance operator side according to the schedule data of the maintenance operator after the present date. Further, the CPU 211 derives a time zone in which no schedule is set from the maintenance operation time Z2 on the store side according to the schedule data of the store manager after the present date. Then, the CPU 211 collates the available time zones of each day of both sides, and if overlapped available time zones are detected, then one of the available time zones having a date which is closest to the present date is decided as a part-replacement operation date and time zone.

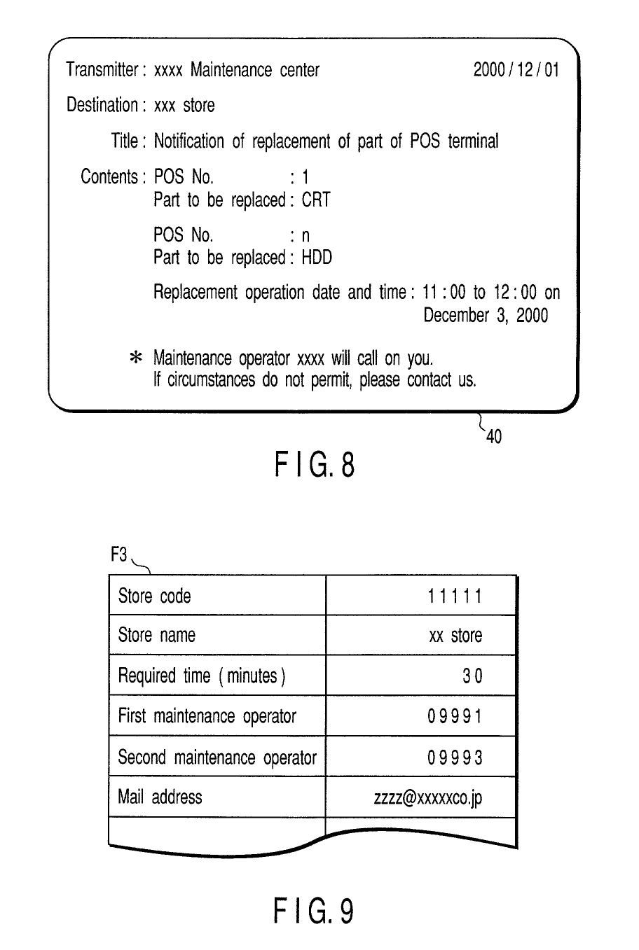

Then, the CPU 211 forms an electronic mail 40 used for informing the store to be maintained of the part-replacement operation date, time zone and the like in the step ST9. FIG. 8 shows one example of the electronic mail 40. On the electronic mail 40, the title “Information about Part Replacement of POS Terminal” is written. Further, as the contents of the mail, the POS number of the POS terminal which requires replacement of a part, the name of the part to be replaced, the part-replacement operation date and time zone, and the name of the maintenance operator who performs the replacement are written. The contents described on the electronic mail 40 are not limited to the example shown in FIG. 8.

Next, the CPU 211 acquires an electronic mail address of the store to be maintained from the store management data file F3 and sets the address as an address of the transmission destination of the electronic mail 40 in the step ST10. Then, it starts the mail software P1 used for transmitting/receiving an electronic mail and transmits the electronic mail 40 onto Internet 30.

Further, the CPU 211 changes work schedule data on the part-replacement operation date and the time zone of replacement operation among the schedule data of the maintenance operator corresponding to the ID code of the maintenance operator appointed in charge of maintenance from data “A” indicating a vacant schedule to data “Q” indicating absence in the step ST11.

As described above, the CPU 211 terminates the remote maintenance process of the POS terminal for one store 10 to be maintained. After this, the CPU 211 selects a next store 10 to be maintained and repeatedly performs the process shown in the flow diagram of FIG. 7.

If the remote maintenance process of the POS terminal has been performed for all of the stores managed by use of the store management data file F3, the server 21 terminates the software P2.

As described in the above embodiment, the remote maintenance process of the POS terminal is periodically performed in the server 21. By performing the process, the presence or absence of the POS terminal 12 which requires replacement of a part is checked for each store 10. In this case, for the store 10 in which the POS terminal 12 which requires replacement of a part is operated, schedule data of the manager of the store 10 and schedule data of the maintenance operator who is in charge of maintenance of the store 10 are collated with each other. Then, the time zone which corresponds to a commonly available vacant time zone of both the store manager and the maintenance operator, has a time length longer than time required for the replacement operation and lies in one date closest to the present date is decided as a part-replacement operation date and time zone. The electronic mail 40 giving notification about the part-replacement operation date and time zone is transmitted to the store computer 11 of the store 10 via Internet 30.

For example, assume now that the electronic mail 40 shown in FIG. 8 is edited and transmitted to the store computer 11 of the store 10. Then, from the electronic mail 40, the manager of the store 10 can get information that it is high time to replace the CRT display of the POS terminal 12 of the POS number=1 and the hard disk drive device of the POS terminal 12 of the POS number=n and confirm that a maintenance operator with a name of “xxxx” will come for replacement operation in a time period from 11 a.m. to 12 a.m. on Dec. 3, 2000. After this, the store manager transmits a return mail indicating that the replacement operation is acknowledged to the maintenance center 20 via Internet 30. Further, data of the part-replacement operation date and part-replacement time zone in the store manager schedule file F2 is updated to previous arrangement data “M”.

If the manager of the maintenance center 20 confirms a response indicating acknowledgement of the part-replacement operation date and time based on the return mail transmitted from the server 21, he may inform the maintenance operator who is in charge of this case to that effect.

Thus, according to the above embodiment, since the server 21 of the maintenance center 20 automatically decides the part-replacement operation date and time zone by collating the schedule of the store manager and the schedule of the maintenance operator with each other, the time and labor required for deciding the replacement operation date and time zone can be alleviated. As a result, in the maintenance center 20, the maintenance management of the POS terminals 12 in the respective stores 10 can be easily and rapidly performed.

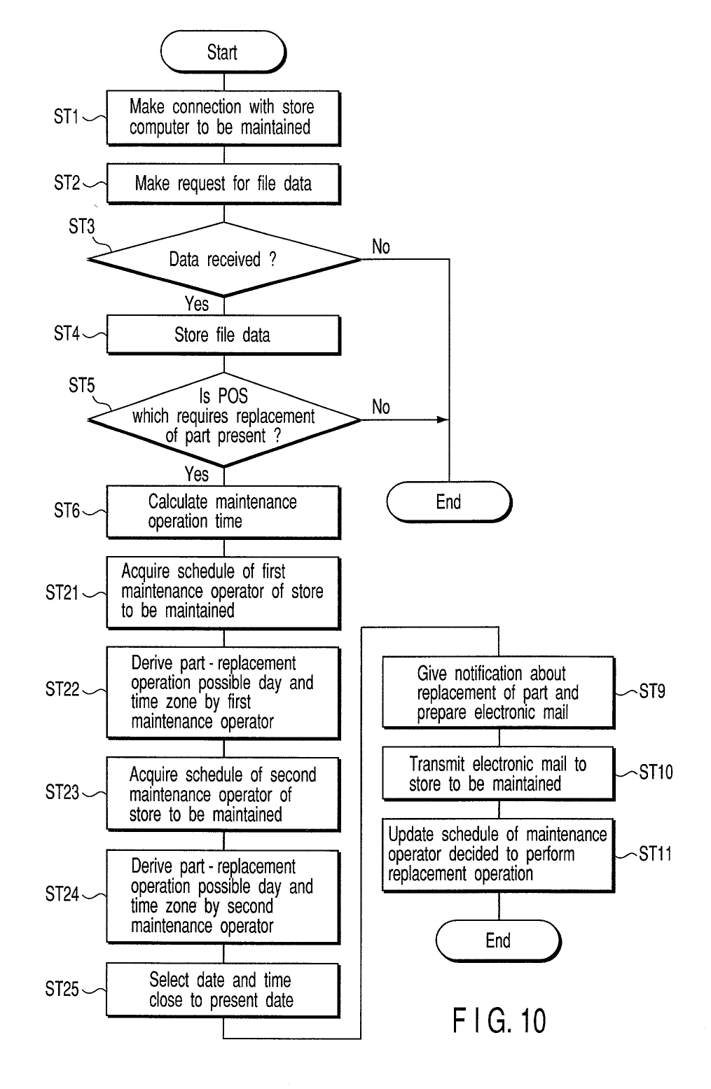

A second embodiment of this invention is explained with reference to FIGS. 9 and 10. The second embodiment is different from the first embodiment in the configuration of the store management data file F3 stored in the server 21 and part of the POS terminal remote maintenance process executed by the CPU 211 of the server 21, and the other portions thereof are the same as the first embodiment.

FIG. 9 is a diagram showing the configuration of a store management data file F3 in the second embodiment. In the second embodiment, two people, first and second maintenance operators, are designated as maintenance operators who are in charge of maintenance of a store 10, and the ID codes thereof are stored in the store management data file F3.

FIG. 10 is a flow diagram showing the main portion of a POS terminal remote maintenance process in the second embodiment. In the above process, the processes of the steps ST1 to ST6 are the same as those of the POS terminal remote maintenance processes in the first embodiment.

In the second embodiment, a CPU 211 of the server 21 acquires the ID code of the first maintenance operator who is in charge of maintenance of the store to be maintained from the store management data file F3 in the step ST21. Then, it searches a maintenance operator schedule file F4 by use of the ID code of the maintenance operator to fetch maintenance operator schedule data stored in correspondence to the ID code of the maintenance operator.

Next, the CPU 211 collates the maintenance schedule data of the first maintenance operator fetched from the maintenance operator schedule file F4 with the store manager schedule data of the store manager schedule file F2 received from the store computer 11 and decides a part-replacement operation possible days and time zones on which the replacement operation can be performed by the first maintenance operator in the step ST22.

Next, the CPU 211 acquires the ID code of the second maintenance operator who is in charge of maintenance of the store to be maintained from the store management data file F3 in the step ST23. Then, it searches the maintenance operator schedule file F4 by use of the ID code of the maintenance operator to fetch maintenance operator schedule data stored in correspondence to the ID code of the maintenance operator.

Next, the CPU 211 collates the maintenance operator schedule data of the second maintenance operator fetched from the maintenance operator schedule file F4 with the store manager schedule data of the store manager schedule file F2 received from the store computer 11 and decides part-replacement operation possible days and time zones on which the replacement operation can be performed by the second maintenance operator in the step ST24.

Next, the CPU 211 collates the part-replacement operation possible days and time zones on which the replacement operation can be performed by the first maintenance operator with the part-replacement operation possible days and time zones on which the replacement operation can be performed by the second maintenance operator, and decides the part-replacement operation possible day and time zone, which is closest to the present date, as a part-replacement operation date and time zone, in the step ST25. Then, the maintenance operator who can perform the part-replacement operation on the part-replacement operation date and time zone is appointed the maintenance operator of the store to be maintained. In this case, if the part-replacement operation possible day and time zone of the first maintenance operator is the same as the part-replacement operation possible day and time zone of the second maintenance operator, the first maintenance operator is appointed the maintenance operator in charge of this case.

After this, the CPU 211 executes the same process as the process of the steps ST9 to ST11 of the first embodiment.

Another embodiment is explained below.

If a CPU 211 of a server 21 is connected with a store computer 11, it first fetches a POS state data file F1. Then, it determines the presence or absence of a POS terminal which requires replacement of a part based on data of the file F1. Only if the POS terminal which requires replacement of a part is present, it fetches a store manager schedule file F2 from the store controller 11 and decides a part-replacement operation date and time. Thus, the operation of the server 21 for fetching the store manager schedule file F2 from the store computer 11 of a store 10 with no POS terminal which requires replacement of a part can be omitted.

The CPU 211 of the server 21 starts the software P2 in response to an operation input from an input section 214. At this time, if a store code is input by use of the input section 214, a POS terminal remote maintenance process is executed only for a store specified by the store code. Thus, the operator of a maintenance center 20 selects a desired store and can always maintain a POS terminal operated in the selected store.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A POS terminal maintenance server which maintains a POS terminal comprising:
a first storage section configured to store a schedule of a manager of a store in which the POS terminal is operated;
a second storage section configured to store a schedule of a maintenance operator who is in charge of maintenance of the POS terminal;
a determining section configured to determine whether or not replacement of respective parts of the POS terminal is necessary based on actual operation data of the respective parts of the POS terminal;
a deciding section configured to decide a part-replacement operation date by collating the schedule of the store manager stored in said first storage section and the schedule of the maintenance operator stored in said second storage section with each other if said determining section determines that replacement of at least one part of the POS terminal is necessary; and
a notifying section configured to give notification about the part-replacement operation date decided by said deciding section.

2. The server according to claim 1, further comprising a schedule updating section configured to update the schedule of the maintenance operator stored in said second storage section when said notifying section gives notification about the part-replacement operation date.

3. The server according to claim 1, wherein said deciding section derives part-replacement operation possible days based on the schedule of the manager in the store in which the POS terminal requiring replacement of a part is operated, derives part-replacement operation possible days based on the schedule of the maintenance operator who is in charge of maintenance of the POS terminal, and decides the earliest one of the replacement operation possible days which is common to both the manager and maintenance operator as a part-replacement operation date.

4. The server according to claim 3, wherein said deciding section derives part-replacement operation possible days for respective maintenance operators if a plurality of maintenance operators who are in charge of maintenance of the POS terminal requiring replacement of a part are present and decides the earliest one of the replacement operation possible days which is common to both the store manager and at least one of the maintenance operators as a part-replacement operation date.

5. A POS terminal maintenance server which maintains a POS terminal comprising:
a first storage section configured to store a schedule of a manager of a store in which the POS terminal is operated;
a second storage section configured to store a schedule of a maintenance operator who is in charge of maintenance of the POS terminal;
a determining section configured to determine whether or not replacement of respective parts of the POS terminal is necessary based on actual operation data of the respective parts in the POS terminal;
a calculating section configured to calculate maintenance operation time based on the time required for replacement of the part and time required for the maintenance operator to move to the store in which the POS terminal is operated when said determining section determines that replacement of the part of the POS terminal is necessary;
a deciding section configured to derive vacant time zones which are longer than the maintenance operation time based on the schedule of the store manager stored in said first storage section and derive vacant time zones which are longer than the maintenance operation time based on the schedule of the maintenance operator stored in said second storage section when said calculating section calculates the maintenance operation time and decides the earliest one of the vacant time zones which is common to both the store manager and maintenance operator as a part-replacement operation time zone; and
a notifying section configured to give notification about the part-replacement operation time zone decided by said deciding section.

6. The server according to claim 5, further comprising a schedule updating section configured to update the schedule of the maintenance operator stored in said second storage section when said notifying section gives notification about the part-replacement operation time zone.

7. The server according to claim 5, wherein said deciding section derives part-replacement operation possible time zones for respective maintenance operators if a plurality of maintenance operators who are in charge of maintenance of the POS terminal requiring replacement of a part are present and decides the earliest one of the replacement operation possible time zones which is common to both the store manager and at least one of the maintenance operators as a part-replacement operation time zone.

8. A POS terminal maintenance server which maintains a POS terminal comprising:
first storage means for storing a schedule of a manager of a store in which the POS terminal is operated;
second storage means for storing a schedule of a maintenance operator who is in charge of maintenance of the POS terminal;
means for determining whether or not replacement of respective parts of the POS terminal is necessary based on actual operation data of the respective parts in the POS terminal;
means for deciding a part-replacement operation date by collating the schedule of the store manager stored in said first storage means and the schedule of the maintenance operator stored in said second storage means with each other if said determining means determines that replacement of at least one of the parts of the POS terminal is necessary; and
notifying means for giving notification about the part-replacement operation date decided by said deciding means.

9. The server according to claim 8, further comprising means for updating the schedule of the maintenance operator stored in said second storage means when said notifying means gives notification about the part-replacement operation date.

10. The server according to claim 8, wherein said deciding means derives part-replacement operation possible days based on the schedule of the manager in the store in which the POS terminal requiring replacement of a part is operated, derives part-replacement operation possible days based on the schedule of the maintenance operator who is in charge of maintenance of the POS terminal, and decides the earliest one of the replacement operation possible days which is common to both the manager and maintenance operator as a part-replacement operation date.

11. The server according to claim 10, wherein said deciding means derives part-replacement operation possible days for respective maintenance operators if a plurality of maintenance operators who are in charge of maintenance of the POS terminal requiring replacement of a part are present and decides the earliest one of the replacement operation possible days which is common to both the store manager and at least one of the maintenance operators as a part-replacement operation date.

12. A remote maintenance system for POS terminals comprising:
a server provided in a maintenance center which performs maintenance of the POS terminals; and
store computers connected to said server via a network and provided in stores in which the POS terminals are operated;
each of said store computers comprising:
a data accumulating section configured to accumulate actual operation data of each of parts constituting the POS terminal; and
a store manager schedule storage section configured to store a schedule of a manager of the store; and
said server comprising:
a data receiving section configured to receive actual operation data of the respective parts of each POS terminal stored in said data accumulating section of said store computer and the schedule of each store manager stored in said store manager schedule storage section via the network;
a maintenance operator schedule storage section configured to store a schedule of a maintenance operator who is in charge of maintenance of the POS terminal;
a determining section configured to determine whether replacement of at least one of the parts of each POS terminal is necessary or not based on the actual operation data of the respective parts of the POS terminal received by said data receiving section;
a deciding section configured to collate the schedule of the store manager received by said data receiving section and the schedule of the maintenance operator stored in said maintenance operator schedule storage section with each other if said determining section determines that replacement of the part of the POS terminal is necessary and decide a part-replacement operation date; and
a notifying section configured to give information about the part-replacement operation date decided by said deciding section to a corresponding one of the stores via the network.

13. The remote maintenance system according to claim 12, wherein said server further comprises a schedule updating section which is configured to update the schedule of the maintenance operator stored in said maintenance operator schedule storage section when said notifying section gives notification about the part-replacement operation date.

14. The remote maintenance system according to claim 12, wherein said deciding section derives part-replacement operation possible days based on the schedule of the manager in the store in which the POS terminal requiring replacement of a part is operated, derives part-replacement operation possible days based on the schedule of the maintenance operator who is in charge of maintenance of the POS terminal, and decides the earliest one of the replacement operation possible days which is common to both the manager and maintenance operator as a part-replacement operation date.

15. The remote maintenance system according to claim 14, wherein said deciding section derives part-replacement operation possible days for respective maintenance operators if a plurality of maintenance operators who are in charge of maintenance of the POS terminal requiring replacement of a part are present and decides the earliest one of the replacement operation possible days which is common to both the store manager and at least one of the maintenance operators as a part-replacement operation date.

16. The remote maintenance system according to claim 12, wherein said notifying section gives notification about the part-replacement operation date to the store in which the POS terminal requiring the replacement of the part is operated by use of an electronic mail utilizing the Internet.

17. The remote maintenance system according to claim 16, wherein said notifying section gives notification about at least one of the name of the part to be replaced and the name of the maintenance operator who will replace the part together with the part-replacement operation date.
